(19) United States
(12) Patent Application Publication
(10) Pub. No.: US 2006/0101310 A1
(43) Pub. Date: May 11, 2006

(54) Device, system and method for verifying integrity of software programs

(76) Inventors: Nimrod Diamant, Kfar Saba (IL); Gershon Bar-On, Mizrah Biniamin (IL); Eliel Louzoun, Jerusalem (IL); Fabian Trumper, Modiin (IL)

Correspondence Address: PEARL COHEN ZEDEK, LLP, 1500 BROADWAY 12TH FLOOR, NEW YORK, NY, 10036, US

(21) Appl. No.: 10/970,653

(22) Filed: Oct. 22, 2004

(51) Int. Cl. G06F 11/00

(52) U.S. Cl. 714/38

(57) ABSTRACT

A method, device and system for using a first verification algorithm or program to evaluate the integrity or authenticity of a second verification program. The first verification program may be stored in a device and may compare a result of such evaluation with a stored expected result. The second verification program may be included in for example an attachable memory unit of the device or other for example add-on memory unit of the device. The second verification program may evaluate the authenticity or integrity of firmware, software, data or other code that is included on the attachable device or elsewhere in the device. If both verification programs confirm the integrity of the respective codes, the firmware or software may be executed or loaded for execution by the device.

### BACKGROUND OF THE INVENTION

Devices that include embedded software, instructions or code may run such embedded software from for example read only memory (“ROM”) or other memory units. Functionality may be added to such devices by the inclusion in such devices of additional customized or vendor specific functional code, instructions, programs. databases or graphics (“firmware”) that may for example be downloaded from a network or otherwise loaded into a memory of a device such as for example random access memory (“RAM”), flash memory units, memory cards, disk on a key or other memory units.

Code that may for example be stored on a ROM unit may authenticate or verify the completeness or integrity of the firmware or functional code that may be stored on for example another memory unit such as for example an attached memory device, to determine for example that the firmware was not miscopied, corrupted, compromised or otherwise unauthorized for use with a particular device. Such authentication or verification may be performed by various means such as for example integrity checking algorithms or test functions such as for example checksums, cyclic redundancy checks (CRC's) or hash functions stored for example in the ROM code or elsewhere in a device. The results of the execution of such algorithms or test functions may be compared with the expected results that may be stored for example in ROM or in other data storage units of a device. The integrity of the functional program, software, code, data, graphics or other firmware may be confirmed if, for example, the results of the integrity checking algorithm's evaluation of a functional program are equal to a stored value.

### BRIEF DESCRIPTION OF THE DRAWINGS

Embodiments of the invention will be understood and appreciated more fully from the following detailed description taken in conjunction with the drawings in which:

FIG. 1 is a schematic diagram of components of a device with embedded ROM and stored firmware in accordance with an exemplary embodiment of the invention;

FIG. 2 is a flow diagram depicting a method of verifying the integrity of a program in accordance with an exemplary embodiment of the invention; and

FIG. 3 is a flow chart of a method in accordance with an embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention. The scope of the invention is not limited to the examples given.

Unless specifically stated otherwise, as apparent from the following discussions, it is appreciated that throughout the specification, discussions utilizing terms such as “processing,” “computing,” “calculating,” “determining,” or the like, refer to the action and/or processes of a processor, computer or computing system, or similar electronic or hardware computing device, that manipulates and/or transforms data represented as physical, such as electronic quantities within the computing system's registers and/or memories into other data similarly represented as physical quantities within the computing system's memories, registers or other such information storage, transmission or display devices.

The processes and displays presented herein are not inherently related to any particular computer, communication device or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein. Embodiments of the invention may be included on a medium or article such as a hard disc, disc on key or other memory unit having stored thereon instruction that when executed implement an embodiment of the invention.

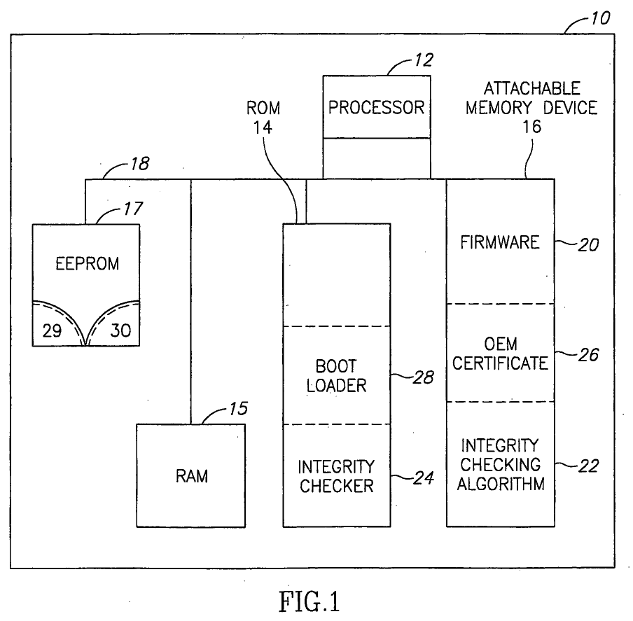

Reference is made to FIG. 1, which is a schematic diagram of components of a device with memory such as for example embedded ROM or other type of storage as well as stored firmware in accordance with an exemplary embodiment of the invention. Device 10 may include a processor 12 that may be connected to, operably linked to or part of a data storage unit such as for example a ROM 14, electrical erasable read only memory (EEPROM) 17, random access memory (RAM) 15 and a memory device 16 such as an attachable memory device or another suitable storage device. Other configurations of processor 12 and memory are possible. In some embodiments the storage functions of EEPROM 17 may be filled by other non-volatile memory devices such as ROM, FLASH or battery backed RAM. In some embodiments, one or more buses 18 may connect various components and memory units in device 10. Memory device 16 may include functionality in addition to memory functionality, such as processing power, communications, etc. In an alternate embodiment, memory device 16 may be included in a remote device, or may be integral to device 10, and need not be attachable.

In some embodiments, ROM 14 may be any suitable memory device that is capable of storing a program or other code that is not intended to be erased or written over as part of the function of device 10 in which ROM 14 is held. In some embodiments, ROM 14 may store for example an operating system, code or programs that may for example operate or execute certain basic operations of device 10. Other programs, instructions or data may be stored on ROM 14, and data storage units other than ROM 14 may be used. ROM 14 may include a loader such as for example a boot loader 28 that may read and load a program from ROM 14 or from another data storage device such as memory device 16 into for example RAM 15 and provide such program to processor 12 for execution from for example RAM 15. In some embodiments such program may be executed directly from memory device 16. In some embodiments, ROM 14 may also store one or more authenticity or integrity checking algorithms such as for example integrity checker 24 that may for example verify the integrity of an integrity checking algorithm 22 or other integrity checking functions that may be stored for example on a memory device 16 such as for example an attachable memory device or in other data storage units that may be operably connected to device 10.

Memory device 16 may include RAM, FLASH memory or other data storage devices that may for example store or otherwise hold functional code, software, data, graphics or firmware 20 that may for example be supplied by an original equipment manufacturer (“OEM”) or other authorized provider of functional code or firmware 20 for device 10. In some embodiments, firmware 20 may provide device 10 with additional functionality beyond the basic functionality that may be provided by for example the programs or data on ROM 14, or may provide device 10 with customized applications, data, graphics etc. that may run on the device 10. A program, such as for example a downloaded program, or a program or other content that is included in a memory device 16, such as for example an attachable memory device, may in some embodiments store or include an integrity checking algorithm 22 or other device, code or testing mechanism that may check for example the integrity of for example firmware 20 that is also included in such memory device 16 to confirm that firmware 20 has not been miscopied, compromised, altered without authorization, corrupted or otherwise not authorized for use with device 10. In some embodiments a memory device 16, such as for example an attachable memory device, may include for example an OEM certificate 26 that may allow authentication of firmware 20. In some embodiments, OEM certificate 26 may be or include a result of a digital signature operation performed on, for example, firmware 20 by the OEM to provide a proof of origin of the content of firmware 20.

Device 10 may also include a data storage unit or data storage area in the form or for example a non-volatile memory unit such as for example EEPROM 17 that may be operably connected to for example processor 12 and that may store one or more values that are not intended to be written over as part of the function of device 10. Other memory structures, forms or units may be used EEPROM 17 may for example store the expected results of integrity checker's 24 evaluation of the integrity of an integrity checking algorithm 22 and other identification information for firmware 20 that may be used to confirm that such firmware 20 or attached memory device 16 is compatible with or authorized for use on device 10. In some embodiments, EEPROM 17 may be read only upon the accessing and executing of one or more programs within ROM 14 such as for example integrity checker 24.

In some embodiments, the results that may be generated by the execution of integrity checker 24 in its evaluation of integrity checking algorithm 22 may be checked against the expected result 30 that may be stored for example in EEPROM 17 to confirm the integrity or authorized status of integrity checking algorithm 22. In some embodiments EEPROM 17 or some other data storage device may also store a device-specific value 29 such as for example a key, random number or other symbol that may for example be used or accepted as an input in the execution of integrity checker 24. Other memory units may be used to store such results and values, and other data may be stored in EEPROM 17.

In operation, when device 10 is activated or at other times during its operation, a processor such as for example processor 12 may call and execute integrity checker 24. Integrity checker 24 may in some embodiments call or read device-specific value 29 from for example EEPROM 17 and may for example use device-specific value 29 as an input in for example an integrity verification algorithm that may be included in integrity checker 24. Integrity checker 24 may for example check the integrity of the code, instructions, data or programs that includes or are included in integrity checking algorithm 22 that may be stored for example in a downloaded program, in memory device 16 or elsewhere in device 10. Such integrity may be checked for example by comparing expected result 30 against the results of the evaluation by integrity checker 24 of integrity checking algorithm 22. Such check may verify whether integrity checking algorithm 22 is valid for the device 10 or processor 12. If integrity checker 24 verifies that integrity checking algorithm 22 is valid, a processor such as for example processor 12 may load and execute integrity checking algorithm 22 which may check and verify the integrity of functional code or other software, data, graphics, content or firmware 20 that may be stored on for example memory device 16. If integrity checking algorithm 22 verifies the integrity of functional code or other software, data, graphics, content or firmware 20, firmware 20 may, for example, be executed from its location in memory device 16 by for example processor 12 or be loaded into RAM 15 and executed by for example processor 12, or by code stored on ROM 14 or on some other memory unit of device 10. Boot loader 28, processor 12 or a program being executed by for example processor 12 may reject or not execute firmware 20, if for example integrity checker 24 fails to verify the integrity of integrity checking algorithm 22, or integrity checking algorithm 22 fails to verify the integrity of firmware 20.

In some embodiments the verification of software, data, instructions, code or other firmware 20 stored on for example a memory device 16, such as for example an attachable memory device, may be split between two or more verification programs. One such verification program may be stored in for example ROM 14 and it may evaluate the integrity of another verification program that may be stored in for example memory device 16 or in a program that may be loaded into another memory unit of device 10. Other numbers of verification programs may be used.

In some embodiments, device 10 may be or include an electronic device such as for example an industrial machine, automobile, medical device, camera, household appliance, airplane, vending machine, personal computer, electronic toy, cellular phone, personal digital assistant or other suitable products that may include an electronic component. In some embodiments, such electronic component or device 10 may include a processor such as processor 12, embedded software or programs or operating systems that may run on such processor 12 and that may be stored in a memory unit such as ROM 14. Such components may also include functional code or other software, data or firmware 20 that may be stored in or attached to the component or device 10.

In some embodiments, processor 12 may be for example a central processing unit of a personal computer or another processor, controller or execution unit suitable for example of running code, software or instructions for a device 10.

Integrity checker 24 may be for example a checksum, Secure Hash Algorithm—version 1, as described in IETF RFC (Internet Engineering Task Force—Request for Comment ) No. 3174 dated September 2001 (SHA1), CRC or one or more other verification programs, algorithms or functions suitable for checking, confirming or verifying that a particular program, code or segment of software or electronically stored data element has not been corrupted, altered or otherwise changed, or that such code or software comports with a particular set of requirements or characteristics. For example, integrity checker 24 may verify or confirm that a verification program such as for example integrity checking algorithm 22 is valid for use on device 10 and has not been corrupted or compromised. In some embodiments, integrity checker 24 may check or verify the integrity of for example an OEM or other certificate that is included in memory device 16 or in firmware 20.

In some embodiments, expected result 30 of the execution of integrity checker 24 on integrity checking algorithm 22 may be stored in for example EEPROM 17, or in some embodiments, in ROM 14 or in another memory unit. In some embodiments such expected result 30 may be a numeric value, though other designations or formats. for such expected result 30 may be used. Expected result 30 may be stored elsewhere.

In some embodiments, device-specific value 29 may be or include a key or random value that may be stored for example on EEPROM 17 and that may be used or accepted as in input when integrity checker 24 checks integrity checking algorithm 22 using for example a HMAC-SHA1 (Keyed-Hashing for Message Authentication Code—Secure Hash Algorithm—version 1), Advanced Encryption Standard, or Cipher Block Chaining Message Authentication Code. Other suitable algorithms may be used. The expected result 30 may be compared to an actual result calculated from running integrity checker 24 on integrity checking algorithm 22, or for example, on OEM certificate 26.

Memory device 16, such as for example an attached memory device, may be or include a data storage unit suitable for holding and storing code, programs or software that may for example be used with device 10 or executed by processor 12. In some embodiments, memory device 16, such as for example an attached memory device, may be or include an add-on component that is manufactured or supplied other than by the manufacturer of supplier of device 10. Memory device 16 may include firmware 20 such as software, programs, instructions, data, code or electronically stored data elements that may contain functions that may control, operate or add functionality to device 10. For example, firmware 20 may include software such as a baseboard management controller or basic input/output software for controlling devices such as a PC platform, or for controlling a cellular phone or a data storage unit. In some embodiments, memory device 16 may also include a software or coded OEM authentication certificate 26 that may indicate to any of processor 12, ROM 14 or device 10 that memory device 16 and/or firmware 20, are suitable for and authorized by for example a manufacturer of device 10 to be run on device 10. In some embodiments, instructions that may include either or both of integrity checking algorithm 22 and integrity checker 24 may be stored for example on an article of manufacture such as for example a storage medium such as a disc, hard drive or other memory unit and/or on a machine accessible medium such as for example, a storage over a carrier wave or storage over a network.

Integrity checking algorithm 22 may be for example a checksum, SHA1, CRC, HMAC-SHA1 or one or more other algorithms suitable for detecting whether code, software or other electronically stored data matches certain requirements or characteristics. In some embodiments, integrity checking algorithm 22 may be provided by an OEM along with the firmware 20, downloadable program, or memory device 16 in which integrity checking algorithm 22 may be included.

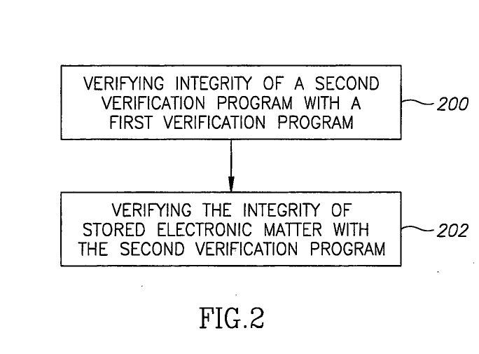

Reference is made to FIG. 2, a flow diagram depicting a method of verifying the integrity of a program in accordance with an exemplary embodiment of the invention. In block 200 a first verification program may verify the integrity of a second verification program. In some embodiments, the first verification program may be stored on a memory unit of the device, such memory unit being separate from the memory unit that stores the second verification program and the program or firmware to be run on the device. In some embodiments, the first verification program may be stored in a ROM unit of a device. In some embodiments, a first verification program may be or include one or more of a checksum, SHA1, HMAC-SHA1, CRC, Hash or other algorithms or processes that may be suitable for checking the integrity of for example a second verification program.

In some embodiments, the expected result that is to be yielded by the first verification program's check of the second verification program may be stored in a third memory unit that may be read by a processor or by a memory unit that stores the first verification program.

In some embodiments the third memory unit may be for example an EEPROM unit that may be accessible only through the execution of the first verification program. In some embodiments, the third memory unit or some other memory unit accessible by the device may store for example a device-specific value such as for example a key or random value. The device-specific value or key may be used as an input in the first verification program for example an HMAC-SHA1 algorithm. The stored and expected value of the execution of the first verification program in its evaluation of for example the second verification program may include or otherwise be a function of the device-specific value.

If the first verification program confirms the integrity of the second verification program, the method may proceed to block 202. In some embodiments of the invention, if the integrity of the second verification program is not confirmed by the first verification program, the method may stop, or certain action may be taken.

In block 202, the second verification program may verify the integrity of a functional pro gram or other stored electronic matter that may have been downloaded into a memory of the device or that may have been included in for example a memory unit of a device, such as for example an attachable memory device. Such program may be or include firmware, data, graphics, algorithms or instructions executable or useable by for example a processor to for example provide additional functionality or enable an operation of a device or a part of a device. In some embodiments, a program may be or include firmware that may be provided by for example a manufacturer, supplier or distributor of a device or a component of the device.

In some embodiments, the second verification program may evaluate for example a program or firmware, and such evaluation may yield a result that is equal to a value that is stored for example on the attachable memory device or elsewhere in the firmware, thereby confirming the integrity and/or authenticity or other characteristics of the program or firmware that was checked by the second verification program. If the program or firmware has been altered, miscopied, compromised or otherwise corrupted or not authorized for use with a particular device for any reason, the result yielded by the second verification program may differ from an expected result and such difference may indicate corruption or unauthorized use of the program or firmware. In some embodiments, if such corruption is detected, the device, or for example a processor within the device may stop or reject the execution of the program or firmware or may stop the loading of the stored electronic matter from for example an attached memory into for example a RAM of the device. Other operations or series of operations may be used.

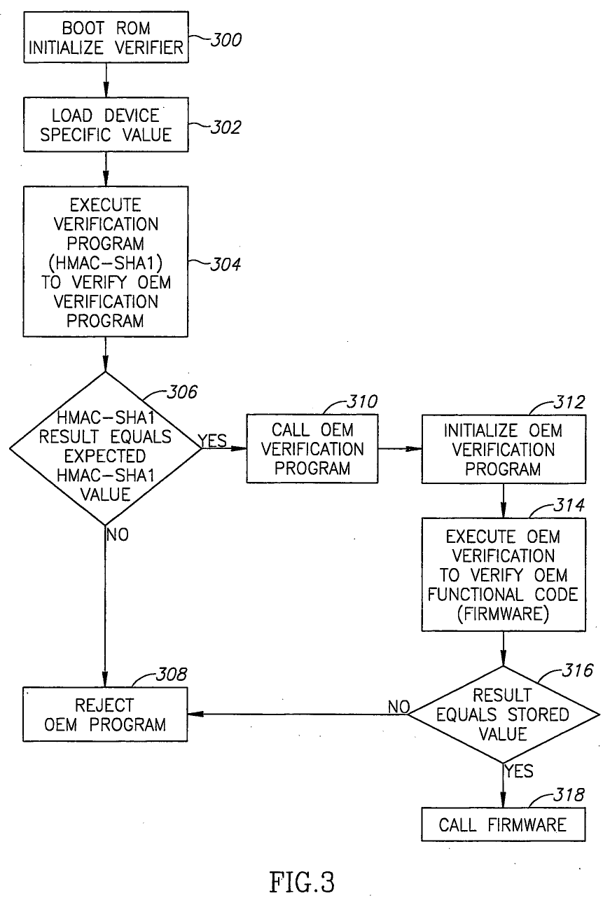

Reference is made to FIG. 3, a flow chart of a method in accordance with an embodiment of the invention. In block 300 a component of a device may boot or load for example a first verification program from for example a ROM into a processor of the device and initialize such verification program. In block 302, a value such as for example a device specific value, such as for example a random value or key that may be stored for example in, a memory unit such as for example an EEPROM operably connected to the ROM, may be loaded into a processor for inclusion as for example an input in a first verification program. In block 304, a first verification program such as for example a HMAC-SHA1 program may be executed to evaluate the integrity of a second verification program such as for example the OEM verification program that may be included for example on an attachable memory device or in a downloaded program. In block 306, a comparison may be made between the result of the execution of the first verification program, such as for example an HMAC-SHA1, and an expected value or result of such execution that may be stored for example in the EEPROM or some other memory unit associated with the device. If such result is equal to the stored expected value, the method may in some embodiments continue in block 310. If such result does not equal the stored value, the method may in some embodiments continue to block 308.

In block 308, a component of the device such as for example a processor may for example issue a signal to reject or not to execute or proceed with the loading of for example a verification program or some other program that may be stored on for example an attachable memory device. Other processes or methods of terminating or blocking an execution of a downloaded program or a program in an attachable memory device may be used. For example a default setting may terminate or refuse to run a program such as for example a second verification program stored on a memory device unless a signal is generated by a processor to indicate that the evaluation of such second verification program by another verification program was successfully completed.

In block 310, a processor or other component of a device may load or call a second verification program such as for example a program supplied by an OEM that may for example be included in a memory device or other component of a device. In block 312 the processor or other component of the device may initialize the OEM verification program for execution.

In block 314, a second verification program such as for example an OEM verification program may be executed to verify the integrity of the OEM functional code, data, graphics, content or firmware that may be included for example on the memory device. In some embodiments OEM verification program may be an HMAC-SHA1, SHA1, CRC or other suitable software or code verification algorithm. Other algorithms may be used. Continuing to block 316, the results of the execution of for example the OEM verification program may be compared with a stored value of the expected results of such verification program. If the actual result equals the stored results, the method may proceed to block 318. If the actual result does not equal the stored results, the method may proceed to block 308, where a component of the device such as for example a processor may issue a signal to reject or not to execute or proceed with the loading of the program stored on a memory device or downloaded into the device's memory. Other processes or methods of terminating an execution of the programs or data in a memory device may be used.

Returning to block 318, the functional code or firmware may for example be loaded into the device and executed by for example a processor or be executed from its location in the external memory device. Other operations or series of operations may be used.

It will be appreciated by persons skilled in the art that embodiments of the invention are not limited by what has been particularly shown and described hereinabove. Rather the scope of at least one embodiment of the invention is defined by the claims below.

We claim:

1. A method comprising:
verifying an integrity of a second verification program with a first verification program; and
verifying an integrity of electronically stored matter with said second verification program.

2. The method as in claim 1, wherein said first verification program is stored on a first memory unit of a device and said second verification program is stored on a second memory unit of said device.

3. The method as in claim 1, comprising:
accepting at said first verification program a device-specific value; and
calculating a result of said verifying said integrity of said second verification with said first verification program based on said device-specific value.

4. The method as in claim 3, wherein said device-specific value is a random value.

5. The method as in claim 3, comprising storing said device-specific value in a memory unit that is accessible only by said first verification program.

6. The method as in claim 1, comprising executing a Hashing for Message Authentication Code Secure Hash Algorithm-version 1.

7. The method as in claim 1, comprising blocking said second verification program from executing upon a failure of said first verification program to verify said second verification program.

8. The method as in claim 1, comprising blocking said electronically stored matter from loading into a memory of a device upon a failure of said second verification program to verify said electronically stored matter.

9. The method as in claim 1, comprising blocking said electronically stored matter from executing in an attached memory device upon a failure of said second verification program to verify said electronically stored matter.

10. A device comprising:
a memory unit to store at least:
a first verification program;
a second verification program; and
a functional program,
wherein said first verification program is to verify the integrity of said second verification program, and said second verification program is to verify the authorization for use of said functional program with said device.

11. The device as in claim 10, comprising a second memory unit to store a device-specific value, wherein said device specific value is accepted as an input in said first verification program.

12. The device as in claim 11, wherein said device-specific value is a random value.

13. The device as in claim 11, wherein said device-specific value is stored in a second memory unit.

14. The device as in claim 10, wherein said first verification program comprises a Hashing for Message Authentication Code Secure Hash Algorithm-version 1.

15. A system comprising:
a functional program;
a first verification program;
a second verification program; and
a processor;
wherein said processor is to execute said first verification program, said first verification program is to verify the integrity of said second verification program, and said second verification program is to verify the integrity of said functional program.

16. The system as in claim 15, comprising a memory unit to store a device-specific value.

17. The system as in claim 16, wherein said memory unit is accessible by said first verification program.

18. The system as in claim 16, wherein said device-specific value is an input in said execution of said first verification program.

19. The system as in claim 15, wherein said second verification program comprises a hashing for message authentication code Hashing for Message Authentication Code Secure Hash Algorithm—version 1.

20. An article comprising a machine accessible medium having stored thereon instructions that when executed result in a first verification program stored on said article verifying the integrity of a second verification program stored on a memory

21. The article as in claim 20, wherein said execution of said instructions further results in the acceptance of a device-specific value as an input into said first verification program.

22. The article as in claim 20, wherein said execution of said instructions further results in the execution of a hashing for message authentication code algorithm.
